(19) United States
(12) Patent Application Publication
(10) Pub. No.: US 2007/0165836 A1
(43) Pub. Date: Jul. 19, 2007

(54) Method, device, terminal and system for processing data flow

(75) Inventor: Li Jiang, Shenzhen (CN)

Correspondence Address: LADAS & PARRY, 26 WEST 61ST STREET, NEW YORK, NY, 10023, US

(73) Assignee: HUAWEI TECHNOLOGIES CO., LTD.

(21) Appl. No.: 11/646,584

(22) Filed: Dec. 27, 2006

(30) Foreign Application Priority Data
Dec. 31, 2005 (CN) 200510121519.6

(51) Int. Cl. H04M 1/00; H04M 9/00

(52) U.S. Cl. 379/399.02

(57) ABSTRACT

A method for processing a data flow, including: transmitting a coding and decoding algorithm plug selected by a calling party or a called party to the pear party, the coding and decoding algorithm plug containing a coding and decoding algorithm, during a call between the calling party and the called party; and one of the calling party and the called party coding a data flow to be transmitted to the other and decoding a data flow received from the other in accordance with the coding and decoding algorithm plug. The invention also relate to a device, a network terminal, and a system using the above method for processing data over a communication link.

### FIELD OF THE INVENTION

The present invention relates to the field of communications, and in particular to a method, a device, a terminal and a system for processing data over a communication link.

### BACKGROUND OF THE INVENTION

IP and TDM transmission mechanisms are typically used in a communication system to transport a data flow. The IP transmission mechanism, in comparison with the TDM transmission mechanism, provides advantages such as more flexible networking, lower transmission cost, overhead, networking construction cost and more service functions and the like, and hence becomes a preferable data transmission mechanism.

In the IP transmission mechanism, as shown in FIG. 1, a communication device needs to convert voice analog signals, i.e. audio signals, into digital signals. That is, a coded data flow is transported over a communication link, and then the received digital signals are restored to the audio signals that can be received directly by a user, where a transcoder (TC) is needed to achieve analog/digital and digital/analog conversions. Generally, the TC of a mobile station is provided within the mobile station, and the TC of a fixed terminal is provided within the terminal or at a media gateway controlled by an access network. If a communication terminal is video-enabling, then a video flow need be subject to coded and decoded prior to being displayed on the terminal.

Since various terminals (including mobile stations and fixed terminals) and communication network devices (including network elements and servers), different countries, operators and communication systems (e.g. CDMA2000/WCDMA/TDSCDMA) may adopt different coding and decoding formats, some of the coding and decoding formats generally used are listed here below as examples:
PCMU Pulse Code Modulation, Mu-law
PCMA Pulse Code Modulation, A-law
13K 13K Vocoder
EVRC Enhanced Variable Rate Codec
SMV Selectable Mode Vocoder

Therefore, it might be hardly possible to use the same coding and decoding format for the data flow during being transported over the communication link. For a smooth communication between both communicating parties, one or more TCs is required to be inserted along a communication pathway in order to achieve a conversion between different coding and decoding formats. The conversion between the different coding and decoding formats brings deterioration of communication quality and a time delay to some extent, and thus the number of TCs provided along the communication link, which are used for the conversion between the different coding and decoding formats, shall be as small as possible, in order to ensure a better communication quality and a smaller transmission delay.

As shown in FIG. 2, in the case that users A and B adopt the same coding and decoding format, for example, the coding and decoding format Codec 1s of the users A and B both adopt the EVRC, they can thus intercommunicate. In the case that the users A and B adopt different coding and decoding formats, for example the coding and decoding format Codec 1 of the user A adopts the EVRC, and the coding and decoding format Codec2 of the user B adopts the 13K, they can not intercommunicate if there is no TC conversion therebetween. With a TC being provided along the communication pathway for the conversion between the Codec1 and the Codec2, the users A and B can intercommunicate.

In general, communication nodes through which the communication link passes support more than one coding and decoding format. Assume that the node A supports three formats of a, b and c, that is, the node A supports a set of coding and decoding formats, A (a,b,c), the node B supports B (c, d, b), and the node C supports C (e, f, d, g), where the ordering of each queue indicates a priority for the formats of nodes. The node A sends to the node B a calling request carrying the set A, the node B sends to the Node C a calling request carrying the set B, and the node C returns to the node B a calling response carrying the intersection set (d) of the nodes B and C. Since the intersection set (b, c) of the nodes A and B does not contain (d), the format b or c is used for the communication between A and B, the format d is used for the communication between B and C. So a TC is required at the node B for the conversion between the two different communication formats. That is, in the case that an intersection set of formats supportable by the three adjacent nodes is empty, a TC has to be used for their intercommunication.

Signaling interaction between communication nodes is shown in Fig.3.

a. When attempting to communicate with the node C, the node A selects the intermediate node B to transport voice signals. The node A sends to the node B a calling request, which carries the Codec 1 and the Codec 2 supported by the node A.

b. The node B receives the calling request from the node A, and then determines that the Codec1 is not supported by the node B while the Codec3 is supported by the node B. The node B sends to the node C a calling request that carries the Codec2 and the Codec3. The calling request may further contain a called number, a service type, a bearer parameter etc.

c. The node C receives the calling request from the node B. Since the Codec2 is not supported, the node C selects the Codec3 from the request, and returns to the node B a calling response carrying the Codec3 selected by the node C. The Codec3 can be used for the communication between the nodes B and C during a subsequent talk process.

d. The node B receives the calling response from the node C. Since the Codec3 has been determined to be adopted between the nodes B and C, and the calling request from the node A does not carry the Codec3, that is, the node A does not support the Codec3, then the node B can only select the Codec 2 to be used between the nodes A and B. The node B returns to the node A a calling response that carries the Codec2 selected by the node B. The Codec2 can be used for the communication between the nodes B and A during a subsequent talk process. The calling response can further carry a hint of off-hook, or, a corresponding subsequent signaling can carry this hint.

Thus, there will be a TC provided at the node B for the conversion between the Codec2 and the Codec 3.

In some occasions, the nodes have different priorities for coding and decoding formats, and thus more than one round of negotiation may be needed for determination of the priorities. With reference to Fig.4, the negotiation will be further described here by way of an example of the SIP protocol (used by both the CDMA2000 and the WCDMA) in a core network.

a. As shown in FIG. 4, an MSCe1 sends to an MSCe2 an INVITE message that carries the SDP1 (SDP stands for Session Description Protocol, and SDP1 stands for Session Description Protocol 1) upon attempting to initiate a calling. The SDP1 contains a list of coding and decoding formats supported by the MSCe1, (a, b, c), and the ordering of the sequence in the list indicates a priority by which the MSCe1 selects the three coding and decoding formats.

b. The MSCe2 returns to the MSCe1 a 183 message that carries an SDP2 containing a list of coding and decoding formats supported by the MSCe2, (c, b), which indicates that the calling service is under switching, and that a coding and decoding format(s) supported by the MSCe2 is (are) selected from the list of the SDP1 and then sent back to the MSCe1, where the format c is preferable to the format b as selected by the MSCe2.

c. If the MSCe1 wishes to select the format b, then the MSCe1 initiates an UPDATE (b) message that carries an SDP3 (b).

d. The MSCe2 returns to the MSCe1 a 200 OK (UPDATE) (SDP3) message indicating an agreement on the use of the format b.

e. The MSCe2 returns a 200 OK (INVITE) message to the MSCe1.

f. The MSCe1 returns to the MSCe2 an ACK message indicating successful receipt of the 200 OK (INVITE) message.

The above has been described in connection with a 183 unreliable message, and an enhanced 183 reliable message have been also specified in the SIP protocol, that is, the following steps are contained between the above steps b and c.

The MSCe1 sends to the MSCe2 a PRACK (183) message indicating successful receipt of the 183 message by the MSCe1.

The MSCe2 returns to the MSCe1 a 200 OK (183) message indicating successful receipt of the PRACK (183) message by the MSCe2.

The prior art may be disadvantageous in the following aspects.

(1) When an intersection set of coding and decoding formats supported by two adjacent nodes is empty, a conversion between coding and decoding formats cannot be performed even if there is of a TC.

(2) The example shown in FIG. 4 involves the steps performed between the core-network MSCe1 and the MSCe2 with two rounds of negotiations to determine the coding and decoding formats, and even more complex negotiations and more rounds can possibly be involved for the determination. Furthermore, the similar situation will occur at the adjacent network nodes throughout the pathway, including the access-network and the core-network.

(3) Due to the numerous nodes over the communication link, a quality loss and a time delay of a voice communication will arise inevitably, even if the same coding and decoding format can be provided between any adjacent nodes and a plurality of TCs can respectively perform conversions between coding and decoding formats.

### SUMMARY OF THE INVENTION

In view of the above, embodiments of the present invention provide a method, a device, a terminal and a system for processing a data flow to achieve better quality and shorter time delay.

An embodiment of the present invention provides a method for processing a data flow, including:

transmitting a coding and decoding algorithm plug selected by a calling party and a called party to the peer party, the coding and decoding algorithm plug containing a coding and decoding algorithm, during a call between the calling party and the called party; and

one of the calling party and the called party coding a data flow transmitted to the other and decoding a data flow received from the other in accordance with the coding and decoding algorithm plug.

Optionally, the calling party may transmit to the called party a calling request that carries the coding and decoding algorithm plug selected by the calling party, or the calling party may transmit to the called party a calling request that carries a set of the coding and decoding algorithm plugs selected by the calling party, and the called party may select one coding and decoding algorithm plug from the set, and then transmit to the calling party a calling response message that carries the selected coding and decoding algorithm plug; or the called party may transmit to the calling party a calling response that carries the coding and decoding algorithm plug selected by the called party.

Optionally, the coding and decoding algorithm plug may be stored in a terminal device of the calling party or in a network server.

Another embodiment of the present invention provides a device for processing a data flow, including:

a script interpreter adapted to store a coding and decoding algorithm plug, to convert program scripts of the selected coding and decoding algorithm plug into a sequence of processor readable instructions, and to transfer the sequence of processor readable instructions to a TC; and

the TC adapted to code a data flow for transmission and to decode a received data flow, or process coding and decoding format-convert for a received data flow.

Optionally, the TC may be provided on a communication terminal of a network or on a gateway of an access network of a fixed network.

A still another embodiment of the present invention provides a network terminal including a device for processing a data flow including:

a script interpreter adapted to store a coding and decoding algorithm plug, to convert program scripts of a selected coding and decoding algorithm plug into a sequence of processor readable instructions, and to transfer the sequence of processor readable instructions to a TC; and

the TC adapted to code a data flow for transmission and to decode a received data flow, or process coding and decoding format-convert for a received data flow.

A further embodiment of the present invention provides a system for processing a data flow, including a plurality of the above network terminals, wherein a calling terminal may code a data flow to be transmitted through a coding and decoding algorithm plug, and a called terminal may decode a received data flow through the same coding and decoding algorithm plug.

Optionally, a coding and decoding algorithm plug selected by one of the calling terminal and the called terminal, which comprises a coding and decoding algorithm, may be transmitted to the other.

As can be seen from above, the nodes over the communication link transfer transparently the coding and decoding algorithm plug up to the communication terminal, and the communication terminal can code a transmitted data flow and decode a received data flow in accordance with the coding and decoding algorithm plug, thus enabling the intercommunication. Therefore, the number of TCs over the communication link can be lowered to a minimum, and a quality loss and a time delay of the intercommunication due to the conversion of a TC between coding and decoding formats can be reduced.

### BRIEF DESCRIPTION OF THE DRAWINGS

FIG. 1 is a schematic diagram for functions of a transcoder (TC);

FIG. 2 is a schematic diagram for a conversion of coding and decoding formats by the TC;

FIG. 3 is a signaling flow chart for a selection of coding and decoding formats among three communication nodes;

FIG. 4 is a signaling flow chart for two rounds of negotiations of coding and decoding formats between two communication nodes;

FIG. 5 is a structural diagram of a device for processing a data flow according to an embodiment of the present invention;

FIG. 6 is a signaling flow chart for obtaining a coding and decoding algorithm plug according to a first embodiment of the present invention; and

FIG. 7 is a principle diagram according to a second embodiment of the present invention.

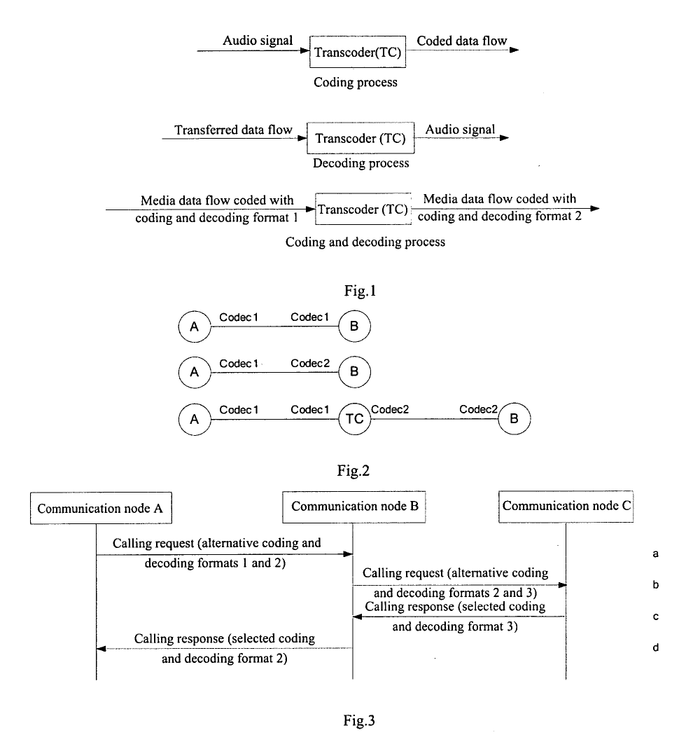

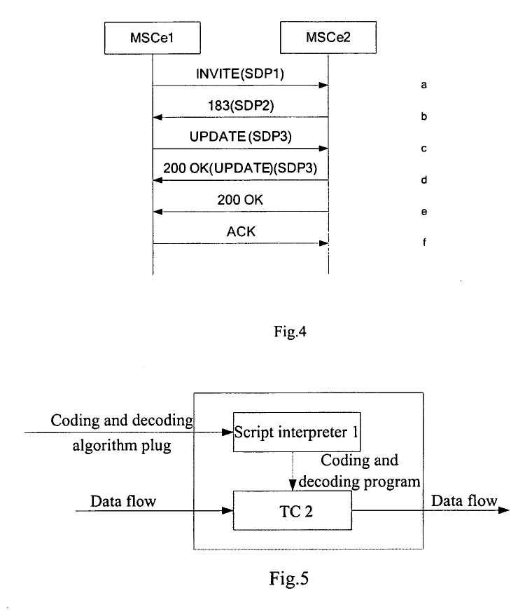

### DETAILED DESCRIPTIONS OF THE EMBODIMENTS

The embodiments of the present invention will be described in detail hereinafter with reference to the drawings.

FIG. 5 illustrates a device for processing a data flow, which includes a script interpreter 1 and a TC 2. Particularly, the script interpreter 1 can store at least one coding and decoding algorithm plug respectively corresponding to one or more coding and decoding formats, and also can temporarily receive and store coding and decoding algorithm plug(s) from outside, which will be deleted upon completion of a calling. The script interpreter 1 analyzes and interprets algorithm description scripts in a coding and decoding algorithm plug, converts them into a sequence of instructions readable by processor, i.e. a coding and decoding program, and transfers the coding and decoding program to the TC 2 for loading. It shall be noted that the coding and decoding algorithm plug(s) stored in the script interpreter 1 can also be stored in other network server and be downloaded when needed.

The TC 2 can code, decode and format-convert a data flow after loading a coding and decoding program.

With the device for processing a data flow shown in FIG. 5 being provided on a mobile station or fixed terminal, or being provided at a gateway of a fixed access network, it is possible to perform coding simultaneously with the conversion of voice analog signals to digital audio signals or perform decoding simultaneously with the conversion of digital audio signals to voice analog signals, and to code and decode video signals before and after their transmission over a channel. In the case that the device for processing a data flow shown in FIG. 5 is provided in a conference processing unit at a media gateway of a master control party during a multi-party call such as a conference call, the decoding and the coding are performed respectively before and after mixing voices of a plurality of parties, and thus a plurality of ways of signals can be transmitted as a single way of signals to achieve a multi-party talk.

Embodiments of a method for processing a data flow according to the present invention will be described hereinafter.

In a first embodiment of the method, a calling party initiates a calling request instructing that both parties shall obtain a coding and decoding algorithm plug during a calling setup procedure. Different cases will be described as following according to different sources of the plug.

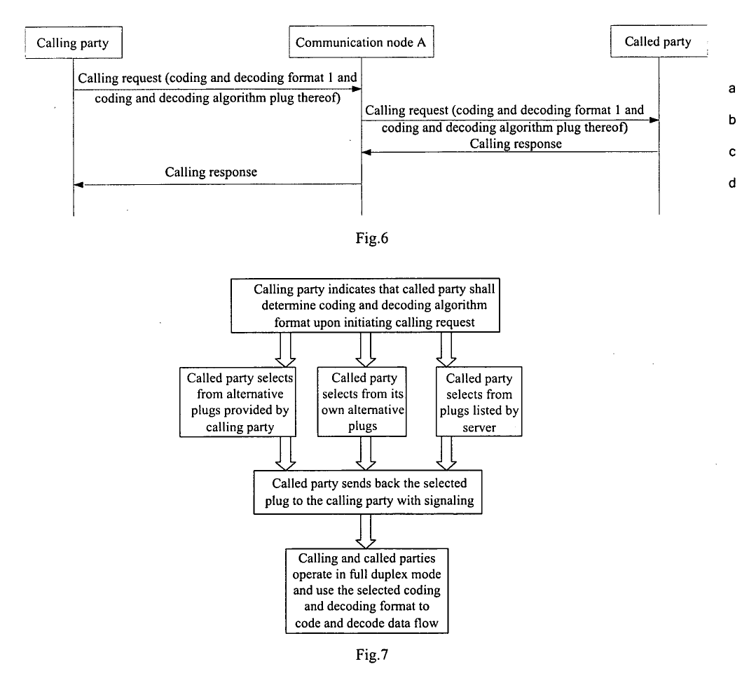

a. The optional coding and decoding algorithm plugs for different formats are stored in a device of the calling party, that is, the device for processing a data flow as shown in FIG. 5 is provided in the device of the calling party. The calling party selects a coding and decoding algorithm plug with a coding and decoding format 1, and sends to a BSC(Base Station Controller)a calling request that carries this plug, according to the flow chart as shown in FIG. 6. Furthermore, the plug along with signaling is transported to the terminal of the called party through each network node of an access network or a core network. Specifically, within the access network, the coding and decoding algorithm plug can be contained in a bearer parameter carried in a CM (Connection Management) Service Request message sent from the BSC to an MSC (Mobile Switch Center) or an Assignment Request message sent from the MSC to the BSC; within the core network, the plug can be carried in a calling request (INVITE) message sent from the MSCe1 to the MSCe2. In FIG. 6, specific node names have been omitted for brevity, and an intermediate node, i.e., a communication node A, represents all nodes. A called party temporarily stores the plug. During the call, both of the terminals operate in a full-duplex mode, and the calling party and the called party use the coding and decoding format of the same coding and decoding algorithm plug to code a data flow to be transmitted and to decode a received data flow. Thus, the data can be transmitted directly over a communication link without being format-converted. At the end of the calling, the called terminal can release the plug or store the plug as its own alternative coding and decoding algorithm plug.

b. Optionally, coding and decoding algorithm plugs for different formats can be stored in a server of a communication network, that is, the script interpreter in the device for processing a data flow as shown in FIG. 5 is provided in the server of the communication network, and the TC is provided in the calling party. The plugs carried in communication signaling (e.g., a calling response) are transmitted to the calling party, and the calling party selects one from the plugs and transfers it to the called party through signaling. Thus, the calling and called parties operate in a full duplex mode and use the same coding and decoding format to code and decode the data flow.

In a second embodiment of the present invention, the calling party initiates a calling request indicating that the called party shall determine a coding and decoding algorithm plug. Any of the following three processing methods can be adopted dependent upon different sources providing the coding and decoding algorithm plug.

a. The calling party can transfer to the called party a set of coding and decoding algorithm plugs selected by the calling party, from which the called party can select one.

b. The called party can directly designate its own coding or decoding algorithm plug(s).

c. In the case of the coding and decoding algorithm plugs of various formats stored in the server of the communication network, the called party can select one from the coding and decoding algorithm plugs provided by the server.

The called party returns to the calling party a response message that carries the selected coding and decoding algorithm plug. Thus, the calling party and called party both operate in a full duplex mode and use the same coding and decoding format to code and decode the data flow.

In a third embodiment of the present invention, during a normal switching process in which the calling and called party establish a calling connection, an agreement can be reached that one party shall provide a coding and decoding algorithm plug. Upon establishment of the calling connection, the party as the provider transmits its selected coding and decoding algorithm plug. Thus, the calling and called party operate in a full duplex mode and use the same coding and decoding format to code and decode the data flow.

It shall be noted that if either of communication parties is a fixed terminal, and the TC in the device for processing a data flow as shown in FIG. 5 is provided at a media gateway controlled by an access network, then coding and decoding algorithm plugs can be loaded on the TC of the media gateway.

Detailed description is not given for all the cases in which the calling and called party initiate a procedure of a calling connection for negotiation to determine a coding and decoding algorithm plug to be used for communication, however, all the cases should be covered within the scope of the present invention.

In a multi-party call, such as a talk involving three or more parties, since initial two parties of the talk have already used a coding and decoding algorithm plug to perform coding and decoding with the same coding and decoding format, a conference processing unit for a media gateway of the master control part can store the coding and decoding algorithm plug. During an access admission for a party joining the talk subsequently, the plug can be transmitted through signaling to that subsequent party, where in turn a data flow can be processed. Assume that three parties, A, B and C, talk to each other in a conference. The coding and decoding algorithm plug on the conference processing unit can decode data flows transmitted from A and B respectively and mix the decoded data flows, and then can code the mixed data flows into a data flow which is in turn transmitted to C. The terminal C receives and decodes that data flow, thus C can receive voice or video signals from A and B simultaneously.

It shall be noted if either of communication parties is a fixed terminal, and the TC in the device for processing a data flow as shown in FIG. 5 is provided at a media gateway controlled by an access network, then coding and decoding algorithm plugs can be loaded on a TC of the media gateway.

While the preferred embodiments of the present invention have been described as above, the scope of the present invention shall not be limited thereto, and those skilled in the art can make various variations and modifications to the embodiments without departing from the scope of the present invention. All these variations and modifications would fall within the scope of the present invention which shall be as defined in the claims thereof.

What is claimed is:

1. A method for processing a data flow, comprising:
transmitting a coding and decoding algorithm plug selected by a calling party or a called party to the peer party, the coding and decoding algorithm plug containing a coding and decoding algorithm, during a call between the calling party and the called party; and
one of the calling party and the called party coding a data flow to be transmitted to the other and decoding a data flow received from the other in accordance with the coding and decoding algorithm plug.

2. The method according to claim 1, wherein the calling party transmits to the called party a calling request that carries the coding and decoding algorithm plug selected by the calling party, or the calling party transmits to the called party a calling request that carries a set of the coding and decoding algorithm plugs selected by the calling party, and the called party selects one coding and decoding algorithm plug from the set, and transmits to the calling party a calling response that carries the coding and decoding algorithm plug selected by the called party, or the called party may transmit to the calling party a calling response that carries the coding and decoding algorithm plug selected by the called party.

3. The method according to claim 1, wherein the coding -and decoding algorithm plug is stored in a terminal device of the calling party or in a network server.

4. The method according to claim 2, wherein the coding and decoding algorithm plug is stored in a terminal device of the calling party or in a network server.

5. The method according to claim 1, wherein during a conference talk, a conference processing unit for a media gateway of a master control party stores the coding and decoding algorithm plug during the talk of two initial talking parties.

6. The method according to claim 5, wherein a part joining the conference talk subsequently obtains the coding and decoding algorithm plug from the conference processing unit through signaling, or obtains the coding and decoding algorithm plug from the conference processing unit upon the establishment of a calling connection.

7. The method according to claim 6, further comprising: the conference processing unit decoding data flows from at least two parties in accordance with the coding and decoding algorithm plug, mixing the data flows, coding the mixed data flow in accordance with the coding and decoding algorithm plug, and transferring the coded data flow to a party other than the at least two parities.

8. A device for processing a data flow, comprising:
a script interpreter adapted to store coding and decoding algorithm plugs, to convert program scripts of a coding and decoding algorithm plug selected from the coding and decoding algorithm plugs into a sequence of processor readable instructions, and to transfer the sequence of processor readable instructions to a TC; and
the TC adapted to code a data flow for transmission and to decode a received data flow, or process coding and decoding format-convert for a received data flow.

9. The device according to claim 8, wherein the TC is provided on a communication terminal of a network or on a gateway of an access network of a fixed network.

10. A network terminal, comprising a device for processing a data flow comprising:
a script interpreter adapted to store a coding and decoding algorithm plug, to convert program scripts of a selected coding and decoding algorithm plug into a sequence of processor readable instructions, and to transfer the sequence of processor readable instructions to a TC; and
the TC adapted to code a data flow for transmission and to decode a received data flow, or process coding and decoding format-convert for a received data flow.

11. A system for processing a data flow, comprising a plurality of network terminals according to claim 11, wherein a calling terminal codes a data flow for transmission through a coding and decoding algorithm plug, and a called terminal decodes a received data flow through the same coding and decoding algorithm plug.

12. The system according to claim 11, further comprising the calling terminal or the called terminal transferring a coding and decoding algorithm plug to the peer part, the coding and decoding algorithm plug containing a coding and decoding algorithm.
